(19) United States
(12) Patent Application Publication
(10) Pub. No.: US 2015/0115551 A1
(43) Pub. Date: Apr. 30, 2015

(54) DRILL CHUCK

(71) Applicant: Roehm GmbH, Sontheim/Brenz (DE)

(72) Inventors: Peter SCHENK, Niederstotzingen (DE); Christian THIEMANN, Muensingen (DE); Rainer WIEDENMANN, Herbrechtingen (DE)

(21) Appl. No.: 14/522,780

(22) Filed: Oct. 24, 2014

(30) Foreign Application Priority Data
Oct. 24, 2013 (DE) 10 2013 111 730.9

(51) Int. Cl. B23B 31/12

(52) U.S. Cl. CPC B23B 31/123; B23B 31/1253
USPC 279/63

(57) ABSTRACT

A drill chuck having a chuck body, on which a threaded ring is guided, which is in engagement with rows of teeth assigned to clamping jaws via an outer thread for the purpose of adjusting the clamping jaws guided in the chuck body, as well as having a clamping sleeve which surrounds the chuck body and may be coupled with the threaded ring in a torque-transmitting manner. The chuck body is formed in multiple parts from a coupling part having a spindle receptacle and from a jaw guiding part, in which guide receptacles run, inclined toward the chuck axis, for the purpose of guiding the clamping jaws.

This nonprovisional application claims priority to German Patent Application No. DE 10 2013 111 730.9, which was filed in Germany on Oct. 24, 2013, and which is herein incorporated by reference.

### BACKGROUND OF THE INVENTION

1. Field of the Invention

The present invention relates to a drill chuck comprising a chuck body, on which a threaded ring is guided, which is in engagement with rows of teeth assigned to clamping jaws via an outer thread for the purpose of adjusting the clamping jaws guided in the chuck body, as well as comprising a clamping sleeve which surrounds the chuck body and may be coupled with the threaded ring in a torque-transmitting manner.

2. Description of the Background Art

Drill chucks of this type, which have a locking device including an outer thread, are known from EP 2 389 264 B1, which corresponds to U.S. Pat. No. 8,702,107, for example. In manufacturing the drill chucks known from the prior art, however, it has proven to be extremely disadvantageous that the chuck body has areas of different outer diameters along its axial extension. If the chuck body, which is made of metal, is manufactured from a solid, machined material—as is usually the case—a great deal of material is lost, which increases the manufacturing costs of the chuck body and thus also those of the entire drill chuck.

### SUMMARY OF THE INVENTION

It is therefore an object of the present invention to reduce the aforementioned disadvantages.

According to an embodiment of the invention, an object is achieved in a drill chuck such that the chuck body is formed in multiple parts from a coupling part having a spindle receptacle and a jaw guiding part, in which guide receptacles run, inclined toward the chuck axis, for the purpose of guiding the clamping jaws.

Due to the chuck body formed in two parts, starting materials of different diameters may now be used for manufacturing the coupling part and the jaw guiding part, whereby the material loss during a machining process for manufacturing the chuck body may be reduced. Moreover, different materials or different manufacturing methods may also be used, due to the two-part design of the chuck body. For example, the coupling part, which is subjected to high stresses and to which the spindle receptacle is assigned, may be manufactured from metal, and the jaw guiding part may be manufactured from plastic in order to reduce the top-heaviness of a drilling machine coupled with the drill chuck.

The guide grooves can be assigned to the guide receptacles, and guide profiles corresponding to the guide grooves can be assigned to the clamping jaws, which are designed as flat jaws. The guiding system resulting therefrom ensures that the clamping jaws do not tilt toward the inside. The danger that the rows of teeth disengage with the outer thread provided on the threaded ring is thus eliminated, which would impair the operation of the drill chuck. Due to the guide grooves and the guide profiles corresponding thereto, it is furthermore ensured that the clamping jaws are able to move only along the guide receptacles, whereby a secure clamping of a tool shaft between the clamping jaws is guaranteed. Within the scope of the invention, however, it is also provided that the clamping jaws are designed as round jaws or as trapezoidal clamping jaws.

It has also proven to be successful if the guide profiles, which have an essentially rectangular cross section, are disposed on the side of the clamping jaws facing away from the row of teeth. In addition to manufacturing advantages, in particular the danger of the guide profiles coming into contact with a tool shaft to be clamped is reduced hereby.

In an embodiment, the diameter of the jaw guiding part can be locally enlarged in the area of the guide receptacles accommodating the clamping jaws. First of all, this saves material, since the outer circumferential of the jaw guiding part may be locally reduced. In addition, this approach also ensures that the wall thickness of the jaw guiding part is homogeneous, whereby manufacturing-induced stresses are reduced. An additional guidance of the clamping sleeve is furthermore provided by the local enlargement of the diameter.

The assembly effort may also be reduced if the jaw guiding part has a cylindrical first partial section on the side facing away from the coupling part, onto which a frustoconical second partial section is molded, and if a cylindrical third partial section is assigned to the jaw guiding part on the side facing the coupling part. The clamping sleeve is supported and guided by the cylindrical first partial section in the assembled state. The guide receptacles are provided in the frustoconical second partial section, and the cylindrical third partial section is used for connection to the coupling part. In the assembled state, the threaded ring is supported on the shoulder, which is formed at the transition between the frustoconical second partial section and the cylindrical third partial section. In addition, this design of the jaw guiding part may achieve the jaw guiding part to have a homogeneous wall thickness, whereby manufacturing-induced stresses are reduced, which may occur during cooling, for example when plastic is used.

A securing structure can be assigned to the coupling part for coupling with the jaw guiding part. Due to the securing structure, which may be formed, for example, by an outer toothing, the coupling part and jaw guiding part may be securely connected to each other in a torque-transmitting manner. Within the scope of the invention, it is also provided hereby that the jaw guiding part and the coupling part are additionally secured by the use of additional securing devices, for example by gluing or welding. It is also provided within the scope of the invention that the jaw guiding part made of plastic is injection-molded onto the coupling part, which is manufactured from metal. It has also proven to be advantageous here if the securing structure is axially delimited by a collar. The position of the jaw guiding part relative to the coupling part is defined by the axial delimitation.

It has also proven to be favorable if a securing sleeve having an toothing provided on the inner circumferential side, preferably a fine toothing, which has an annular band for axially securing the clamping sleeve, is assigned to the jaw guiding part. Due to the use of the securing sleeve, the jaw guiding part is furthermore locally reinforced in the cylindrical first partial section, which represents a sensitive area, in particular when using a jaw guiding part manufactured from plastic. In the case of a jaw guiding part manufactured from plastic, moreover, manufacturing tolerances may be compensated for by the toothing assigned to the securing sleeve, which digs into the jaw guiding part, whereby the concentricity characteristics of the drill chuck are improved. The annular band which axially secures the clamping sleeve also protects the drill chuck should the latter unintentionally strike a wall during operation.

It has proven to be particularly advantageous if a clamping ring, which is rotatably fixedly connected to the threaded ring, is axially movably supported thereon and has an axially acting lock toothing for forming a toothing engagement with a mating toothing, is assigned to the chuck body. An axially acting locking device is implemented thereby, whereby the locking mechanism always remains securely closed even in the case of strong vibrations or high dynamics.

It has furthermore proven to be successful if the mating toothing is provided on a toothed ring assigned to the coupling part. The toothed ring may thus be easily pressed onto the coupling part and thereby simultaneously forms an axial securing system for the locking ring which is rotatably fixedly coupled with the threaded ring.

It has also proven to be advantageous if at least one control cam, upon which a radial cam provided on a terminating disk assigned to one of the clamping sleeves, is assigned to the locking ring supported on the threaded ring via an elastic restoring element for the purpose of axially adjusting the locking ring. By rotating the clamping sleeve, the locking ring supported on the threated ring may thus be axially adjusted, via the radial cam, between a drilling configuration, in which the toothing engagement between the lock toothing and the mating toothing is closed, and a clamping configuration, in which the locking ring is axially adjusted against the elastic restoring element, whereby the toothing engagement between the lock toothing and the mating toothing is released. A relative rotation between the threaded ring and the chuck body is thus possible in the clamping configuration, whereby the clamping jaws guided in the chuck body are axially adjusted. In the drilling configuration, where the lock toothing assigned to the locking ring is in engagement with the mating toothing that is provided on the toothed ring, the threaded ring is now rotatably fixedly connected to the chuck body, whereby a relative rotation between the threaded ring and the chuck body is not possible, which would result in a loosening of the clamping jaws. Due to the restoring element, a force continuously directed in the direction of the mating toothing acts upon the locking ring, whereby the functional reliability of the drill chuck according to the invention is increased. The terminating disk is rotatably fixedly and axially immovably coupled with the clamping sleeve, due to a suitable securing geometry.

In this connection, it has also proven to be particularly favorable if the at least one control cam provided in the terminating disk is delimited by at least one engagement seat which defines the drilling configuration and/or the clamping configuration. The control cam assigned to the locking ring may then engage with the engagement seat, whereby the locking ring has particular, well defined end positions.

To achieve a drill chuck as compact as possible, it has also proven to be successful if the slope of the clamping jaws with regard to the chuck axis is taken from a range which is preferably between 15° and 25° and which is particularly preferably 20°. Due to the resulting short drill chuck, in particular the top-heaviness of a drilling machine connected to the drill chuck may be noticeably reduced.

A first securing groove can be assigned to the coupling part for the purpose of securing the toothed ring. As a result, the axial position of the toothed ring may be set by inserting a first retaining ring. Also, a second securing groove can be assigned to the threaded ring for the purpose of securing the terminating disk. For example, a second retaining ring, which secures the axial position of the terminating disk on the threaded ring, may be easily inserted into the second securing groove.

In an embodiment, the coupling part can be made from a first material and the jaw guiding part can be made from a second material, and if the first material and the second material are different. In particular, by designing the jaw guiding part from a plastic or from a fiber-reinforced plastic, the top-heaviness of the drill chuck according to the invention may be significantly reduced. By using the aforementioned materials, guide receptacles of different shapes may be implemented in the jaw guiding part, since they do not absolutely have to have a round cross section. Likewise, in a jaw guiding part manufactured from plastic, the coupling part may be manufactured from a metal for the purpose of reinforcing the area which is subjected to increased stresses. Within the scope of the invention, however, a metal jaw guiding part is also provided, which may be manufactured using a metal injection-molding process.

For use in drilling machines of a higher power class, it has also proven advantageous if the lock toothing provided on the locking ring and the mating toothing assigned to the chuck body and corresponding to the lock toothing are formed from a plurality of locking teeth having a locking flank and a tensioning flank. The forces needed for tensioning and for emergency opening are set by suitably selecting the slopes of the locking flanges and the tensioning flanks. The steeper the slope of the locking flank, the greater the application of force needed for disengagement. In this connection, it has proven to be advantageous if the slope of the locking flank of the toothing engagement provided between the lock toothing and the mating toothing is greater than or equal to the slope of the tensioning flank. A tensioning of the drill chuck is thus always possible.

It has also proven to be advantageous if the slope of the locking flank is greater than or equal to 45°, preferably greater than 60° and especially preferably greater than 80°. Although a higher application of force is needed as the slope of the locking flank increases, in order to facilitate an emergency opening of the drill chuck according to the invention in the drilling configuration, higher dynamic influences of the drilling machine used may also be transmitted as the slope increases.

To be able to transmit the greatest possible torques, it has also proven to be advantageous if the locking flanks of the locking teeth are oriented parallel to the tensioning flanks. Due to the 90° slope resulting hereby, it may be ensured, in particular, that an unwanted unlocking of the drill chuck is not possible.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a side view of a first specific embodiment of the drill chuck according to the invention;

FIG. 2 shows a top view of the drill chuck, with the clamping jaws closed;

FIG. 3 shows a longitudinal sectional view along section III-III from FIG. 2;

FIG. 4 shows an exploded view of the first specific embodiment;

FIG. 5 shows another exploded view of the first specific embodiment;

FIG. 6 shows a partial sectional view of the chuck body of the first specific embodiment;

FIG. 7 shows a side view of the chuck body;

FIG. 8 shows a sectional view along section VIII-VIII from FIG. 7;

FIG. 9 shows a perspective view of the chuck body;

FIG. 10 shows a partial sectional view of the chuck body according to the invention;

FIG. 11 shows detail XI from FIG. 10;

FIG. 12 shows a partial view of the first specific embodiment;

FIG. 13 shows detail XIII from FIG. 12 in the drilling configuration;

FIG. 14 show a partial sectional view of the first specific embodiment in the clamping configuration;

FIG. 15 shows detail XV from FIG. 14;

FIG. 16 shows a partial sectional view of the back end of the first specific embodiment;

FIG. 17 shows a toothing engagement with detail XVIII; and

FIGS. 18.1 through 18.4 show detail XVIII from FIG. 17 in toothing engagements of different designs;

FIG. 19 shows a top view of another specific embodiment, including trapezoidal clamping jaws;

FIG. 20 shows a side view of the drill chuck from FIG. 19;

FIG. 21 shows a side view of the drill chuck having trapezoidal clamping jaws;

FIG. 22 shows a sectional view along section XXII-XXII from FIG. 21; and

FIG. 23 shows a perspective view of the chuck body from direction XXIII in FIG. 21.

### DETAILED DESCRIPTION

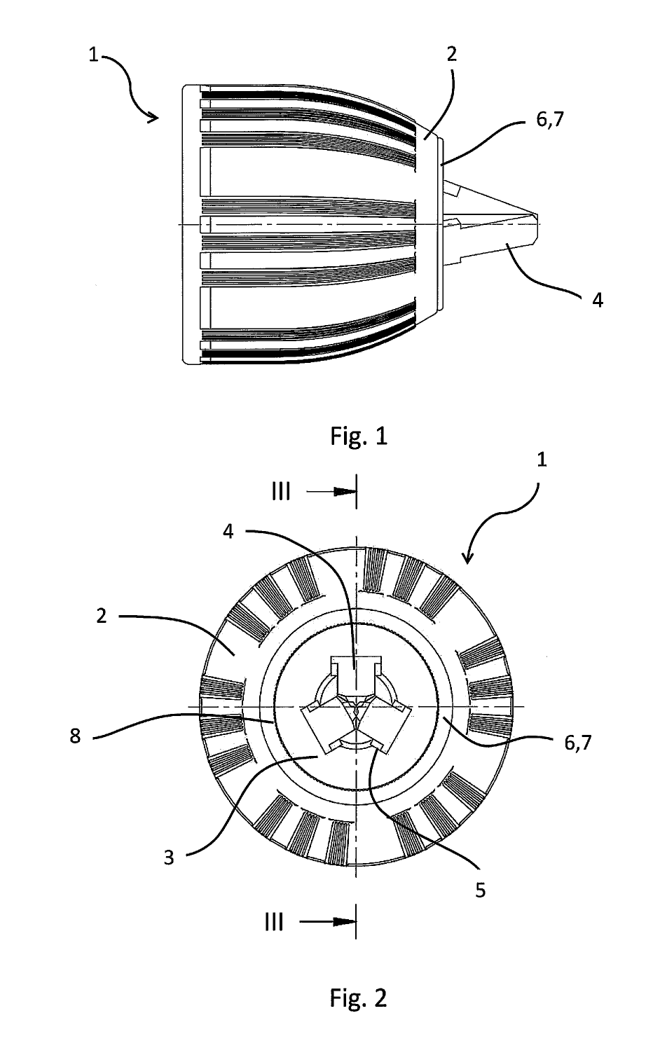

FIG. 1 shows a side view of an embodiment of drill chuck 1 according to the invention. In addition to clamping sleeve 2, which surround a drill chuck 3, which is not illustrated in the drawing, FIG. 1 also shows clamping jaws 4, which are guided in guide receptacles 5 in chuck body 3. On the front side facing clamping jaws 4, clamping sleeve 2 is axially secured by a securing sleeve 7 having an annular band 6.

FIG. 2 shows a top view of the end of drill chuck 1 having clamping jaws 4. In addition to clamping sleeve 2, the top view illustrated in FIG. 2 shows, in particular, chuck body 3 and securing sleeve 7, which is pressed onto chuck body 3 with the aid of toothing 8 provided on the inner circumferential side and which axially secures clamping sleeve 2 with the aid of annular band 6. In addition, chuck body 3 is reinforced in the front part by securing sleeve 7.

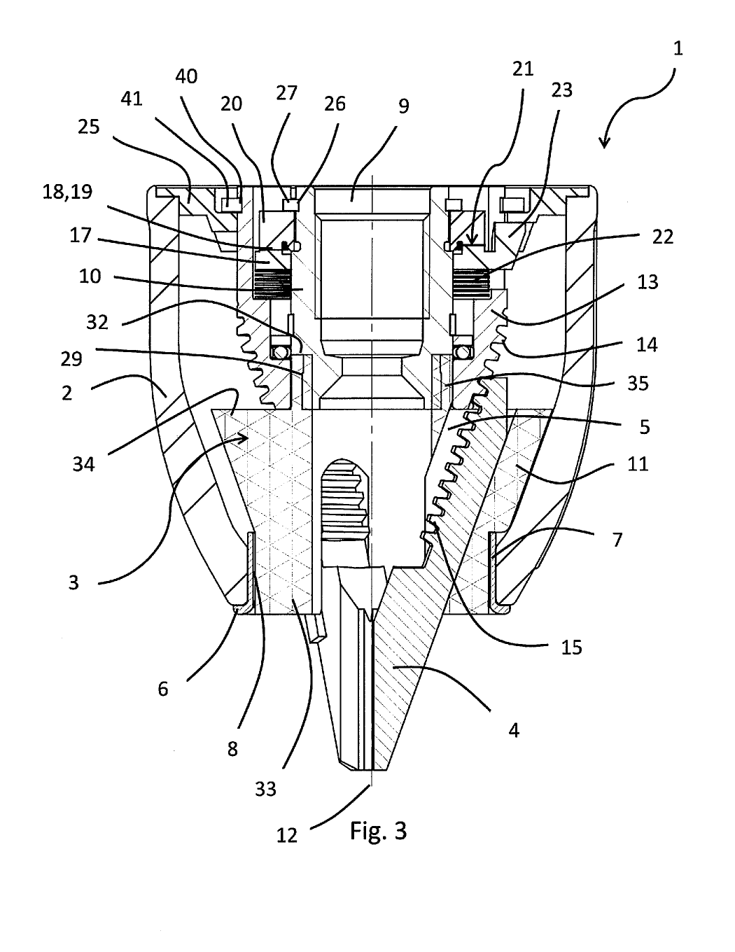

FIG. 3 shows, in a longitudinal section, a sectional view of the first specific embodiment along section III-III from FIG. 2. Note that chuck body 3 is formed in multiple parts from a coupling part 10 having a spindle receptacle 9 and from a jaw guiding part 11 manufactured from plastic, in which guide receptacles 5 run, inclined toward chuck axis 12, for the purpose of guiding clamping jaws 4. To adjust clamping jaws 4, a threaded ring 13 is provided in the illustrated exemplary embodiment, which is in engagement with rows of teeth 15 assigned to clamping jaws 4, with the aid of an outer thread 14. An axially movable locking ring 17, which is rotatably fixedly connected to threaded ring 13 is supported thereon. Locking ring 17 has an axially acting lock toothing 18 for forming a toothing engagement with a mating toothing 19 assigned to chuck body 3. In the illustrated exemplary embodiment, mating toothing 19 is provided on a toothed ring 20 assigned to coupling part 10. Due to lock toothing 18 and mating toothing 19 corresponding thereto, a locking device 21 is provided, with the aid of which chuck body 3 may be rotatably fixedly connected to threaded ring 13 for the purpose of preventing unintentional disengagement of clamping jaws 4. Locking ring 17, which is axially movably mounted on threaded ring 13, is supported on threaded ring 13 via an elastic restoring element 22.

To adjust locking ring 17 from the clamping configuration, in which lock toothing 18 of locking ring 17 is out of engagement with mating toothing 19 assigned to toothed ring 20, into the drilling configuration, in which the toothing engagement between lock toothing 18 and mating toothing 19 is established, a control cam 23 is assigned to locking ring 17, upon which a radial cam 24 may act, which is provided on a terminating disk 25 assigned to clamping sleeve 2. In the illustrated exemplary embodiment, radial cam 24 provided in terminating disk 25 is delimited by an engagement seat 28 defining the drilling configuration and the clamping configuration. By rotating clamping sleeve 2, locking device 21 is easily adjusted between the drilling configuration and the clamping configuration. The slope of clamping jaws 4 with respect to chuck axis 12 is 20° in the illustrated exemplary embodiment, which results in a very compact drill chuck. To axially secure toothed ring 20, a first securing groove 26 is assigned to coupling part 10, into which a first retaining ring 27 is inserted, which fixes the axial position of toothed ring 20. Terminating disk 25 in the illustrated exemplary embodiment is rotatably fixedly connected to clamping sleeve 2 and axially secured by a second retaining ring 41, which is inserted into a second securing groove 40 provided in threaded ring 13.

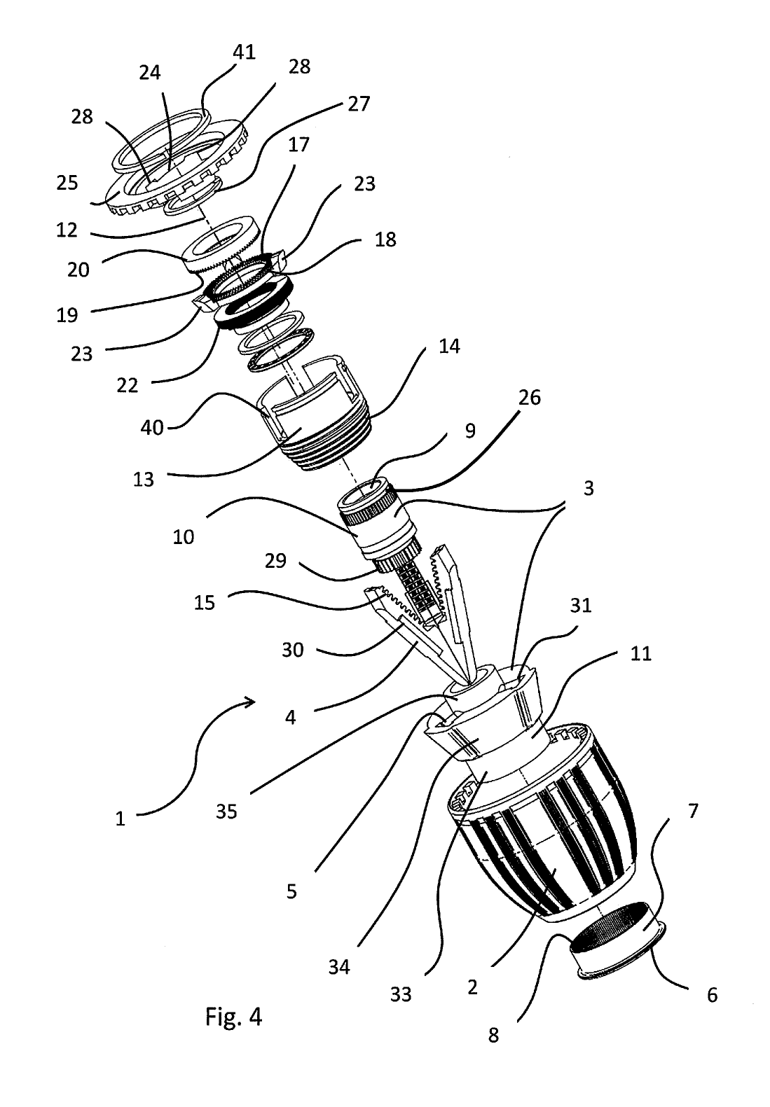

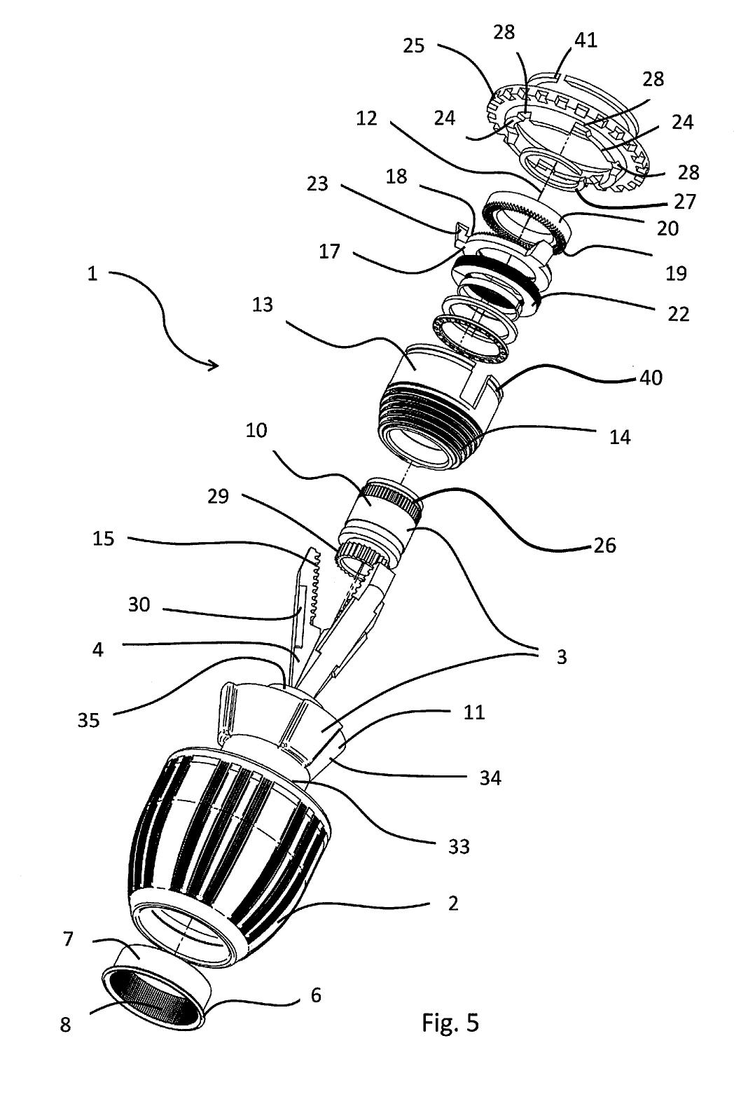

FIG. 4 and FIG. 5 each show an exploded view of the first specific embodiment of drill chuck 1 according to the invention, from different perspectives. In particular, FIG. 4 shows two-part chuck body 3, which is formed from coupling part 1, manufactured from metal, and jaw guiding part 11, manufactured from plastic. A securing structure 29, into which jaw guiding part 11 is pressed during assembly and additionally injection-molded, is assigned to coupling part 10 for the purpose of coupling with jaw guiding part 11. Clamping jaws 4 used in the illustrated exemplary embodiment are designed as flat jaws and each have a guide profile 30 on the side facing away from row of teeth 15, which has a rectangular cross section in the illustrated exemplary embodiment and may be inserted into guide grooves 31, which are provided in jaw guiding part 11 molded from plastic in the area of guide receptacles 5.

FIG. 6 shows a partial sectional view of chuck body 3 of the first specific embodiment of drill chuck 1 according to the present invention, formed from coupling part 10 and jaw guiding part 11. The view illustrated in FIG. 5 shows that securing structure 29, which is provided on coupling part 10, is axially delimited by a collar 32. A defined fit is ensured hereby during the joining of chuck body 3. FIG. 6 furthermore shows guide receptacles 5, which are inclined toward chuck axis 12 and are provided for guiding clamping jaws 4 and have guide grooves 31, into which guide profiles 30 provided on the clamping jaws may be inserted. As is apparent from FIG. 7 in particular, a secure guiding of the clamping jaws is ensured hereby. The three-part structure of jaw guiding part 11 is also apparent from FIG. 6. On the end facing away from coupling part 10, jaw guiding part 11 has a cylindrical first partial section 33, onto which a frustoconical second partial section 34 is molded, in which the guide receptacles of the clamping jaws are provided. A cylindrical third partial section 35 is provided on the end of jaw guiding part 11 facing coupling part 10, which is used to couple jaw guiding part 11 to coupling part 10.

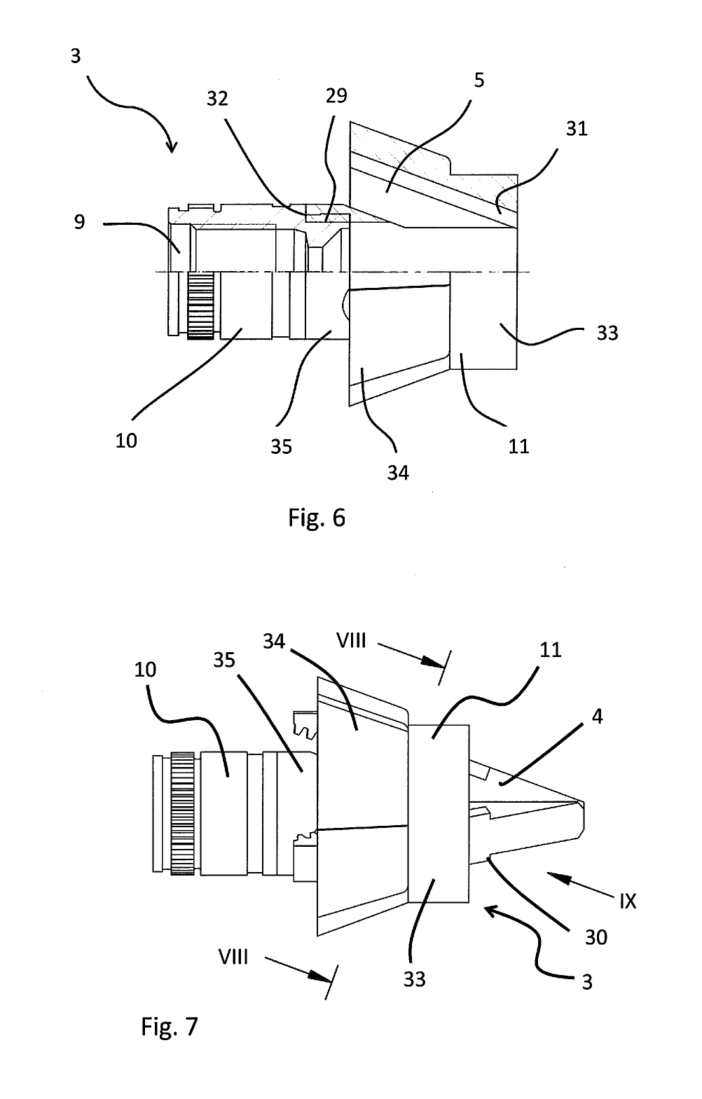

FIG. 8 shows a sectional view along section VIII-VIII from FIG. 7. Guide grooves 31 provided in guide receptacles 5, which are used as guides for guide profiles 30 of clamping jaws 4, are again apparent. A tilting of clamping jaws 4 toward the inside or toward the outside is effectively prevented by guide grooves 31 and guide profiles 30 corresponding thereto.

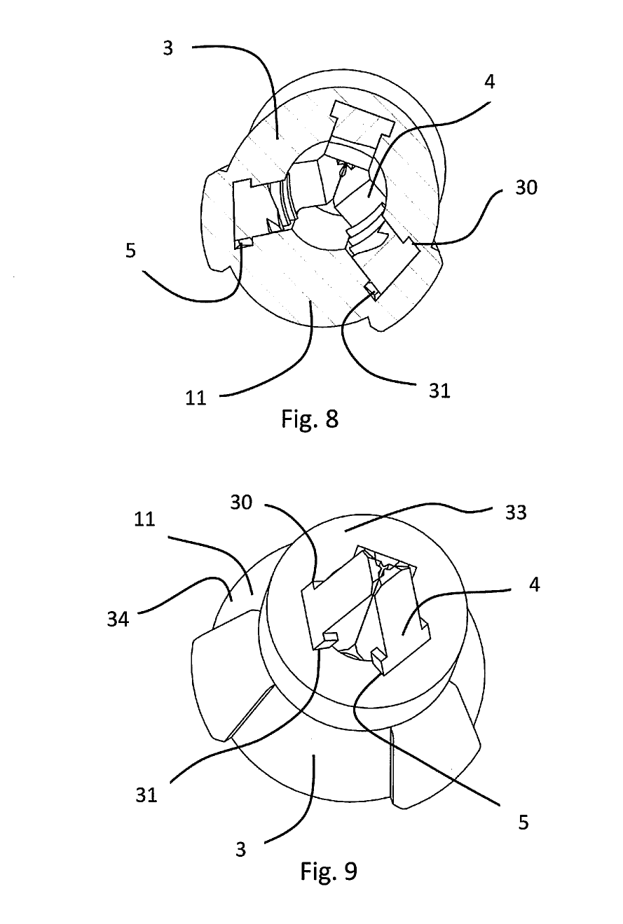

FIG. 9 also shows that the diameter of frustoconical second partial section 34 is locally enlarged in the area of guide receptacles 5 accommodating clamping jaws 4. In particular, the fact is achieved hereby that the wall thickness of jaw guiding part 11 remains homogeneous, whereby manufacturing-induced stresses that frequently occur during the cooling of plastic, are avoided.

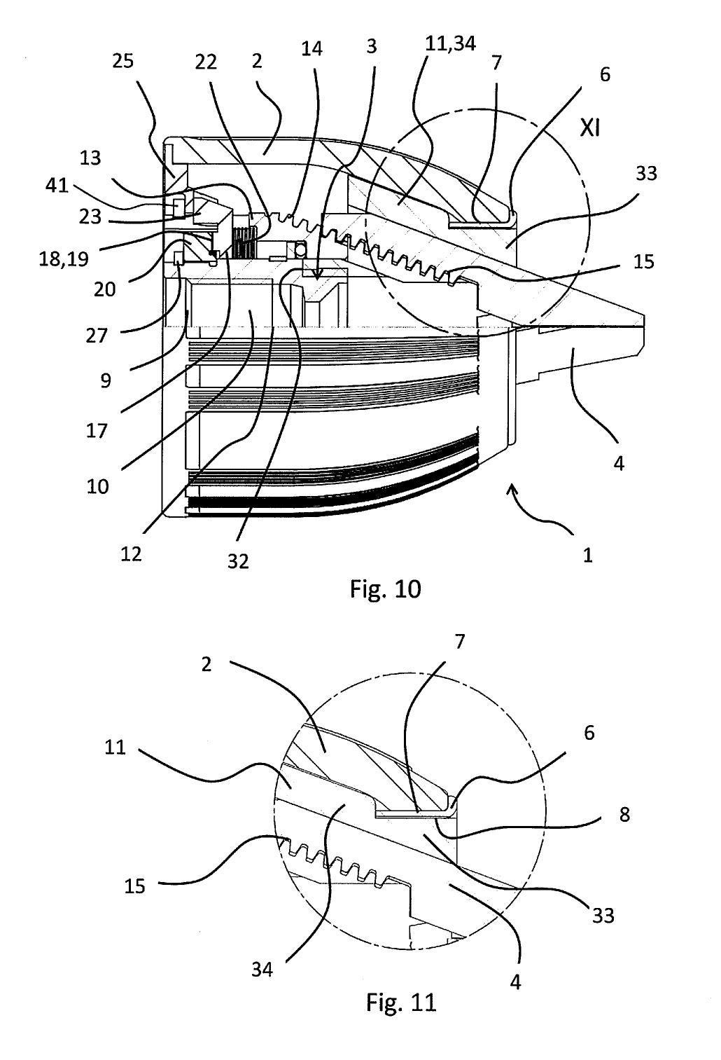

FIG. 10 shows a partial sectional view of a first specific embodiment of drill chuck 1 according to the invention in the drilling configuration. Lock toothing 18 of locking ring 17 is in toothing engagement with mating toothing 19, which is assigned to chuck body 3. As is apparent, in particular, from Detail XI illustrated in FIG. 11, securing sleeve 7 is mounted on the end of clamping sleeve 2 facing away from the terminating disk, pressed onto cylindrical first partial section 33 of jaw guiding part 11 with the aid of toothing 8 provided on the inner circumferential side and reinforces it locally. It is also apparent from Detail XI that clamping sleeve 2 is axially secured by annular band 6, which is assigned to securing sleeve 7.

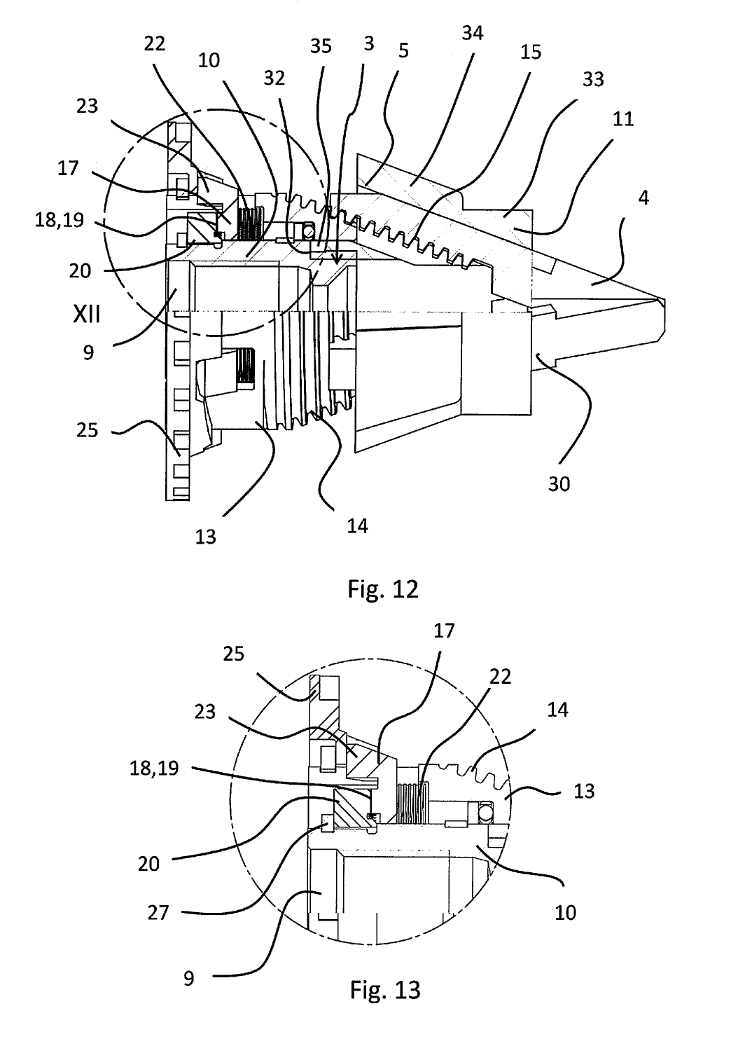

FIG. 12 and Detail XIII illustrated in FIG. 13 show that, in the drilling configuration, which is illustrated in the drawing, the toothing engagement between lock toothing 18 and corresponding mating toothing 19 is established, and control cam 23 is engaged with engagement seat 28 defining the drilling configuration.

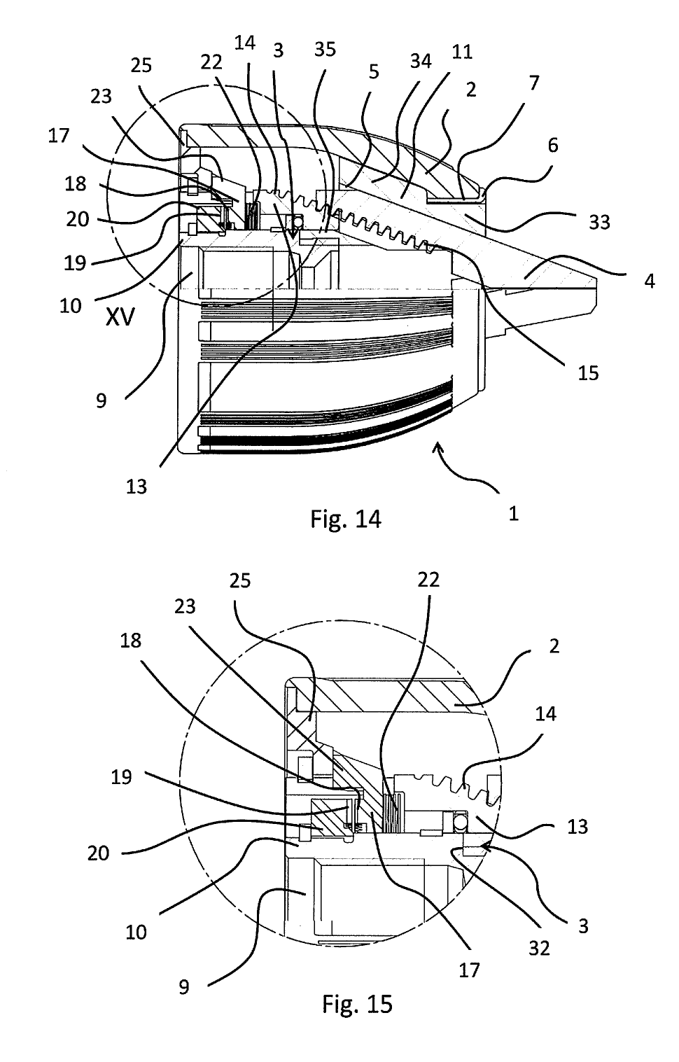

In the clamping configuration, which is illustrated in FIG. 14—as is apparent, in particular, in Detail XV illustrated in FIG. 15—the clamping engagement between lock toothing 18 and mating toothing 19 assigned to chuck body 3 is released. Locking ring 17 is adjusted in the direction of the clamping jaws, along threaded ring 13 by radial cam 24 provided on terminating disk 25, against elastic restoring element 22. Control cam 23 is engaged with engagement seat 28 defining the clamping configuration.

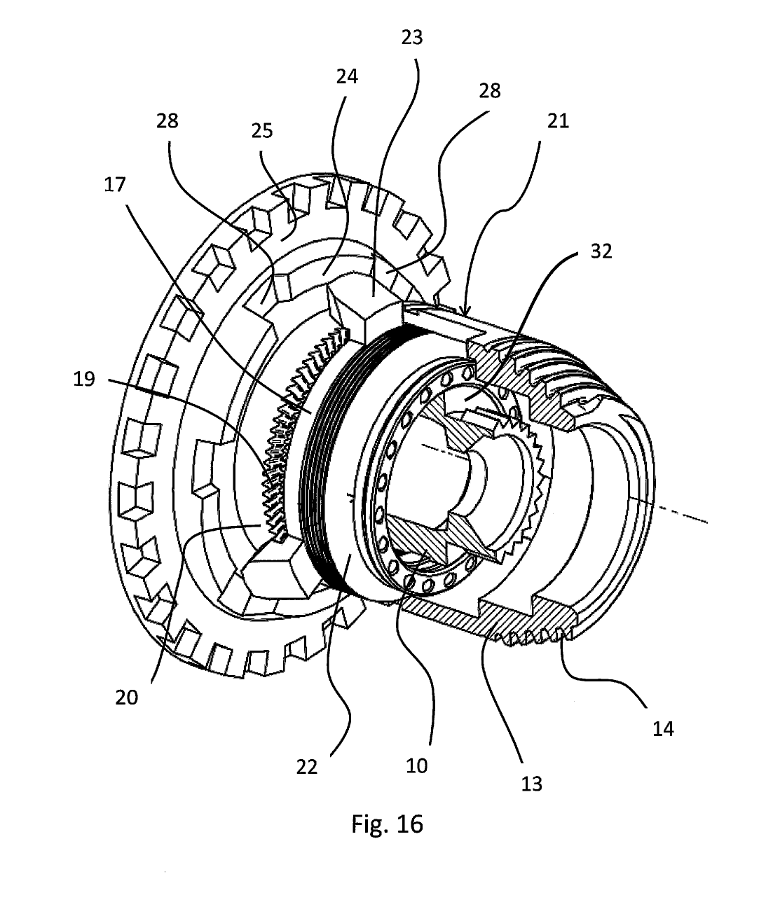

FIG. 16 shows important parts of locking device 21 in a partial sectional view. In particular, the design of engagement seats 28 provided in terminating disk 25 should be noted, with which control cam 23 is engaged in the drilling configuration or in the clamping configuration, as well as radial cams 24 delimited by engagement seats 28.

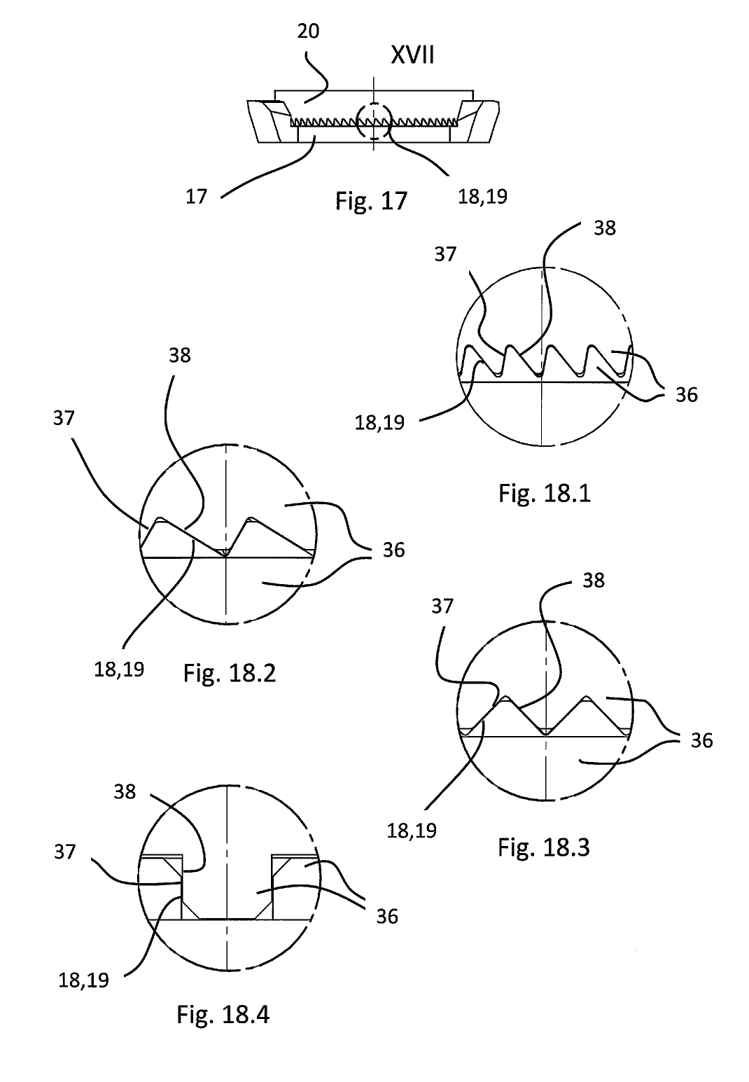

Locking ring 17 is illustrated in FIG. 17, which is in engagement with mating toothing 19 assigned to toothed ring 20/chuck body 3 with the aid of lock toothing 18. In Detail XVIII from FIG. 17, FIGS. 18.1 through 18.4 show different shapes of lock toothing 18 and corresponding mating toothing 19. The variants of lock toothing 18 and mating toothing 19 illustrated in FIGS. 18.1 through 18.4 are always formed from a plurality of locking teeth 36, which each have a locking flank 37 and a tensioning flank 38. The slope of locking flank 37 in FIGS. 18.1 through 18.4 is always equal to or greater than the slope of tensioning flank 38, which is always 45° in FIGS. 18.1 through 18.3. The slope of locking flank 37 is 80° in FIG. 18.1, 60° in FIGS. 18.2 and 45° in FIG. 18.3. The steeper the slope of locking flank 37, the more force needs to be applied to ensure an emergency opening of locking device 21. Due to the rather flat slope of tensioning flank 38, a tensioning of drill chuck 1 in the drilling configuration is possible with only a light application of force. In the locking teeth illustrated in FIG. 18.4, locking flank 37 is parallel to tensioning flank 38 and has a slope of 90°. In this case, neither a tensioning nor an emergency opening of locked drill chuck 1 is possible.

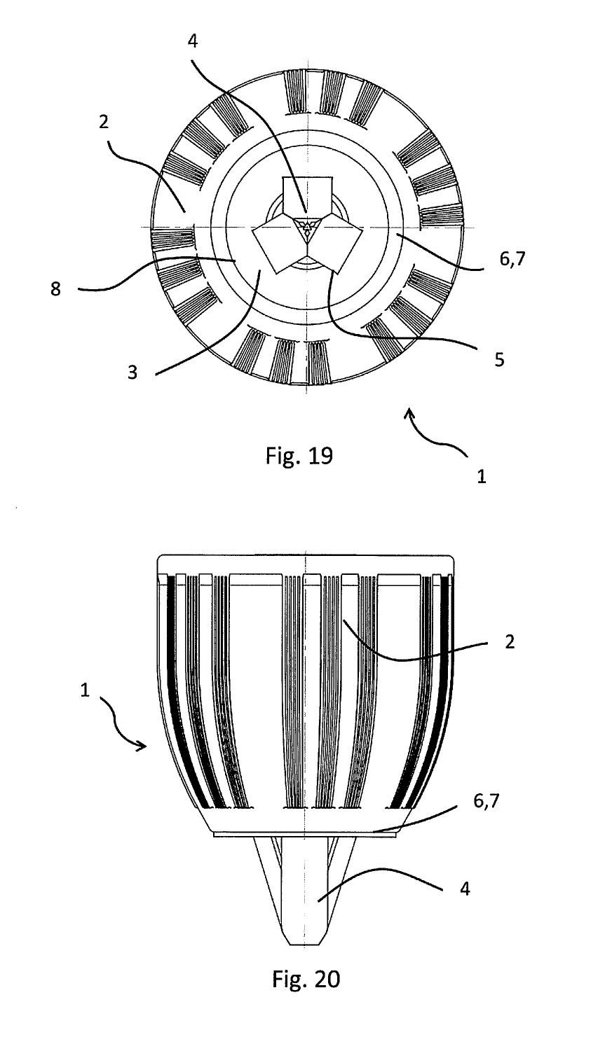

FIG. 19 shows a side view of another specific embodiment of drill chuck 1 according to the invention, including trapezoidal clamping jaws 4. Clamping jaws 4 are again guided in guide receptacles 5, which are provided in chuck body 3. A side view of the additional specific embodiment of the drill chuck having trapezoidal clamping jaws 4 is illustrated in FIG. 20. In particular, annular band 6 of securing sleeve 7 pressed onto chuck body 3, which axially secures clamping sleeve 2, is apparent herein.

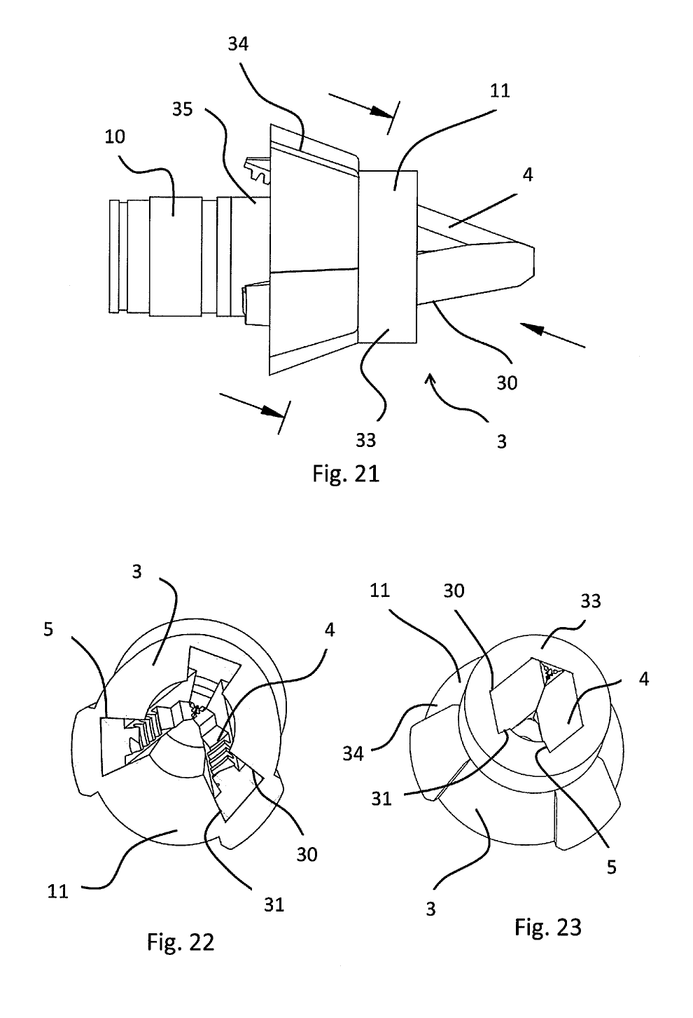

FIG. 21 shows a side view of chuck body 3 having trapezoidal clamping jaws 4, which are guided in jaw guiding part 11 of chuck body 3.

In particular, the trapezoidal cross section of clamping jaws 4 and the corresponding cross section of guide receptacles 5 provided in jaw guiding part 11 are apparent from the sectional view of chuck body 3 illustrated in FIG. 22 along section XXII-XXII from FIG. 21. In particular, a titling of clamping jaws 4 is prevented by the trapezoidal cross section of clamping jaws 4, used as guide profile 30, and the corresponding shape of guide receptacles 5, which act as guide grooves 31.

As is also apparent from the perspective view of chuck body 3 illustrated in FIG. 23, in this specific embodiment jaw guiding part 11 is also locally enlarged in the area of guide receptacles 5 accommodating trapezoidal clamping jaws 4, i.e., in the frustoconical, second partial section 34.

The operation of the drill chuck according to the invention is explained once again below.

In the clamping position, locking ring 17 is adjusted axially against elastic restoring element 22, and lock toothing 18 is not in engagement with mating toothing 19. Control cam 23 is engaged with engagement seat 28 defining the clamping configuration. If the user actuates the drive of a drilling machine connected to drill chuck 1, a relative rotation occurs between chuck body 3 and threaded ring 13, whereby clamping jaws 4 are closed or opened, depending on the operating direction of the drilling machine. Alternatively, the user may rotate the clamping sleeve manually to adjust clamping jaws 4. The rotation of clamping sleeve 2 via locking ring 17 is transmitted to threaded ring 13. When clamping jaws 4 come into abutment with a tool shaft to be clamped, the resistance increases and control cam 23 is disengaged from engagement seat 28 defining the clamping position, and a relative rotation, limited by engagement seat 28, occurs between clamping sleeve 2 and threaded ring 13. Control cam 23 is guided along radial cam 24, which is provided between engagement seats 28, and transferred by elastic restoring element 22 into the drilling configuration, in which control cam 23 is engaged with engagement seat 28 defining the drilling configuration. Lock toothing 18 is now in engagement with mating toothing 19. If the drive continues to be actuated, or if clamping sleeve 2 continues to rotate in the clamping direction, a tensioning is possible by suitably selecting lock toothing 18 and mating toothing 19, i.e., the toothing engagement is released by a withdrawal of lock toothing 18, and lock toothing 18 slides over mating toothing 19. The adjustment takes place in the opposite sequence when clamping jaws 4 are opened.

Starting from the drilling configuration, in which lock toothing 18 is in engagement with mating toothing 19, the toothing engagement between lock toothing 18 and mating toothing 19 is released by rotating clamping sleeve 2, and locking ring 17 is axially adjusted by radial cam 24 on threaded ring 13 and then engages with engagement seat 28 defining the clamping configuration. Clamping jaws 4 may now be opened by actuating a drive of a drilling machine which is coupled with chuck body 3 and whose operating direction was changed in comparison with the clamping operation. Alternatively, the relative rotation between the chuck body and the threaded ring may also take place by manually rotating clamping sleeve 2.

If it is not possible to manually rotate clamping sleeve 2 when clamping jaws 4 are clamped, for the purpose of releasing the locking engagement, due to a blocked locking device 21, which may occur during percussion drilling in particular, an emergency release may be facilitated with the aid of the drive of a drilling machine coupled with chuck body 2 by suitably selecting the slope of locking flanks 37.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A drill chuck comprising:
a chuck body on which a threaded ring is guided that is in engagement with rows of teeth assigned to clamping jaws via an outer thread for adjusting the clamping jaws guided in the chuck body; and
a clamping sleeve that surrounds the chuck body and is coupled with the threaded ring in a torque-transmitting manner,
wherein the chuck body is formed in multiple parts from a coupling part having a spindle receptacle and from a jaw guiding part, in which guide receptacles run inclined toward the chuck axis for guiding the clamping jaws.

2. The drill chuck according to claim 1, wherein guide grooves are assigned to the guide receptacles and guide profiles corresponding to the guide grooves are assigned to the clamping jaws, which are designed as flat jaws.

3. The drill chuck according to claim 2, wherein the guide profiles, which have an essentially rectangular cross section, are disposed on a side of the clamping jaws facing away from the row of teeth.

4. The drill chuck according to claim 1, wherein the diameter of the jaw guiding part is locally enlarged in the area of the guide receptacles accommodating the clamping jaws.

5. The drill chuck according to claim 1, wherein the jaw guiding part has a cylindrical first partial section on a side facing away from the coupling part onto which a frustoconical second partial section is molded, and wherein a cylindrical third partial section is assigned to the jaw guiding part on a side facing the coupling part.

6. The drill chuck according to claim 1, wherein a securing structure is assigned to the coupling part for coupling with the jaw guiding part.

7. The drill chuck according to claim 6, wherein the securing structure is axially delimited by a collar.

8. The drill chuck according to claim 1, wherein a securing sleeve having a toothing or a fine toothing provided on an inner circumferential side, which has an annular collar for axially securing the clamping sleeve is assigned to the jaw guiding part.

9. The drill chuck according to claim 1, wherein a clamping ring, which is rotatably fixedly connected to the threaded ring, is axially movably supported thereon and has an axially acting lock toothing for forming a toothing engagement with a mating toothing assigned to the chuck body.

10. The drill chuck according to claim 9, wherein the mating toothing is provided on a toothed ring assigned to the coupling part.

11. The drill chuck according to claim 9, wherein at least one control cam, upon which a radial cam provided on a terminating disk assigned to the clamping sleeve, is assigned to the locking ring supported on the threaded ring via an elastic restoring element for axially adjusting the locking ring.

12. The drill chuck according to claim 11, wherein the at least one radial cam provided on the terminating disk is delimited by at least one engagement seat defining the drilling configuration and/or the clamping configuration.

13. The drill chuck according to claim 1, wherein the slope of the clamping jaws with regard to the chuck axis is taken from a range which is between 15° and 25° or which is 20°.

14. The drill chuck according to claim 1, wherein a first securing groove is assigned to the coupling part for securing the toothed ring.

15. The drill chuck according to claim 1, wherein a second securing groove is assigned to the threaded ring for securing the terminating plate.

16. The drill chuck according to claim 1, wherein the coupling part is made of a first material and the jaw guiding part is made of a second material, and wherein the first material and the second material are different.

17. The drill chuck according to claim 1, wherein the lock toothing provided on the locking ring and the mating toothing assigned to the chuck body and corresponding to the lock toothing are formed from a plurality of locking teeth, each having a locking flank and a tensioning flank.

18. The drill chuck according to claim 17, wherein a slope of the locking flank of the toothing engagement formed between the lock toothing and the mating toothing is greater than or equal to a slope of the tensioning flank.

19. The drill chuck according to claim 17, wherein a slope of the locking flank is greater than or equal to 45°, greater than 60°, or greater than 80°.

20. The drill chuck according to claim 17, wherein the locking flanks of the locking teeth are oriented parallel to the tensioning flanks.
